(19) United States
(12) Patent Application Publication
(10) Pub. No.: US 2012/0265568 A1
(43) Pub. Date: Oct. 18, 2012

(54) SYSTEM AND METHOD FOR DETERMINING THE RETURN ON INVESTMENT OF AN APPLICATION

(75) Inventors: James Edward Marshall, (US); Jaqai Mickelsen, (US); Darren Joseph Raymond, (US)

(73) Assignee: Accenture Global Services Limited

(21) Appl. No.: 13/331,071

(22) Filed: Dec. 20, 2011

Related U.S. Application Data
(60) Provisional application No. 61/427,556, filed on Dec. 28, 2010.

(51) Int. Cl. G06Q 10/06

(52) U.S. Cl. 705/7.11

(57) ABSTRACT

Systems and methods consistent with the invention relate to calculating a return on investment score of an application for an organization. In one exemplary implementation, the system and methods may receive a plurality of data items that reflect content created by a user, each of the plurality of data items corresponding to data item categories; receive a plurality of designations associated with the data items; and calculate return on investment scores for the data item categories based on the designations and the data items.

### BRIEF DESCRIPTION

1. Technical Field

The present invention relates to determining a return on investment and, more particularly, to determining an organization's return on investment of an application, such as a social media web application.

2. Background

An application is a computer program or group of programs designed for end users. Examples of applications include database programs, word processors, spreadsheets, social media technology, and the like.

Social media technology has become increasingly popular in the business environment. Indeed, businesses are expending resources to increasingly deploy social media technology in the workplace to enable collaborative work among employees and offices of the organization. Because deploying this technology can be costly, and its use may be time consuming, it is important for the business to know whether the technology they have implemented is providing a return on investment. Organizations may thus benefit by measuring the “utility” or “usefulness” of this social media technology both on a small scale, and at a scale across the organization.

Accordingly, there is a need for improved systems and methods for measuring an organization's return on investment (ROI) of an application.

### BRIEF SUMMARY

Consistent with an exemplary embodiment of the present invention, there is provided a computer-readable storage medium having instructions which, when executed on a processor, perform a method for calculating a return on investment of an application for an organization, the method comprising: receiving a plurality of data items that reflect content created by a user, each of the plurality of data items corresponding to data item categories; receiving a plurality of designations associated with the data items; and calculating return on investment scores for the data item categories based on the designations and the data items.

Consistent with another exemplary embodiment of the present invention, there is provided a system for calculating a return on investment of an application for an organization comprising: a module for receiving a plurality of data items that reflect content created by a user, each of the plurality of data items corresponding to data item categories; a module for receiving a plurality of designations associated with the data items; and a module for calculating return on investment scores for the data item categories based on the designations and the data items.

Consistent with a further exemplary embodiment of the present invention, there is provided a method for calculating a return on investment of an application for an organization, the method comprising: receiving a plurality of data items that reflect content created by a user, each of the plurality of data items corresponding to data item categories; receiving a plurality of designations associated with the data items; and calculating return on investment scores for the data item categories based on the designations and the data items.

Consistent with another exemplary embodiment of the present invention, there is provided a computer-readable storage medium having instructions which, when executed on a processor, perform a method for calculating a return on investment of an application for an organization, the method comprising: receiving a plurality of data items that reflect content created by a user, the data items corresponding to data item categories; receiving designation-related information associated with each of the designations; receiving user information associated with users of the application, the user information comprising the names of the users and the locations of the users; receiving query information indicating a first search parameter and a second search parameter; comparing the first search parameter and the second search parameter to the user information, designations, and designation-related information to determine a query match; and calculating a return on investment score for the data item categories based on the query match, total numbers of designations associated with the query match, and total numbers of data items associated with the query match.

It is to be understood that both the foregoing general description and the following detailed description are exemplary and explanatory only and are not restrictive of the invention, as claimed. Further features and/or variations may be provided in addition to those set forth herein. For example, the present invention may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, show certain aspects of the present invention and, together with the description, help explain some of the principles associated with the invention. In the drawings:

FIG. 1A is a block diagram of an exemplary return on investment-based system consistent with the present invention;

FIG. 1B is a block diagram of an exemplary embodiment of return on investment-based server consistent with the present invention;

FIG. 2 is a flow chart demonstrating an exemplary return on investment process consistent with an exemplary embodiment of the present invention;

FIG. 3 is a flow chart demonstrating an exemplary process for collection of a data item designation and information related to the data item designation consistent with an exemplary embodiment of the present invention;

FIG. 4 is a flow chart demonstrating an exemplary process for calculating the return on investment of an application consistent with an exemplary embodiment of the present invention;

FIG. 5 is an exemplary query display generated by an exemplary embodiment of the present invention;

FIG. 6 is an exemplary return on investment statistics display consistent with an exemplary embodiment of the present invention;

FIG. 7 is an exemplary display of an interface screen of the application consistent with an exemplary embodiment of the present invention.

### DETAILED DESCRIPTION

Reference will now be made in detail to the exemplary embodiments consistent with the present invention. Wherever possible, the same reference numbers will be used throughout the drawings to refer to the same or like parts. It is apparent, however, that the embodiments shown in the accompanying drawings are not limiting, and that modifications may be made without departing from the spirit and scope of the invention.

Systems and methods consistent with the invention provide a return on investment-based system for measuring an organization's return on investment of an application. To this end, the return on investment-based system (“ROI-based system”) may collect data item designations associated with a data item. As used herein, the term “data item” broadly refers to content created by a user, and the detailed description below provides further examples of such data items. When collecting a data item designation, the ROI-based system may provide one or more data items, and determine whether the data item(s) has received one or more designations. As used herein, the term “designation” broadly refers to content or a classification that is applied to a data item by one or more users. For example, a user may indicate that a particular data item is “helpful” and thus designate the data item as “helpful.” A designation may either be created independently by the user (e.g. the user may enter the text “helpful”) or may be predetermined by the application (e.g., the application may allow a user to select the designation from one or more predetermined sample designations).

Upon receiving the designation(s) of the data item, the designations and information related to the designation may be stored by the system. Examples of information related to the designation may be the date of the designation, the time of the designation, the user making the designation, the location of the user making the designation, and the like. The ROI-based system may then calculate a return on investment based on the category of the data item (hereinafter “data item category”) (e.g., whether the data item can be categorized as a “comment,” a “photo,” a “video,” a “weakness,” a “strength,” or any other category of data item), the number of data items per data item category, and the number of designations per data item category. The ROI-based system can use the designations, designation-related information, and return on investment calculation to generate return on investment statistics, and update the interface of the application.

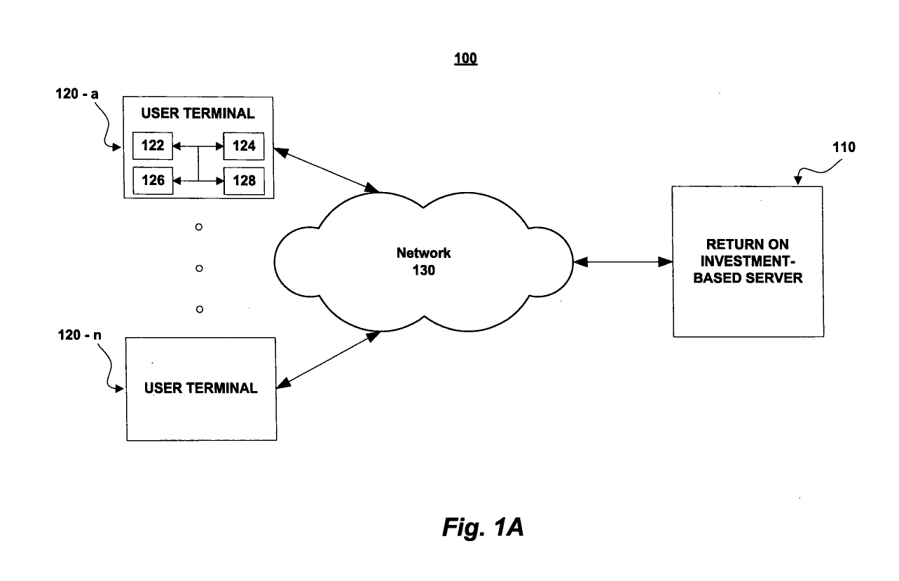

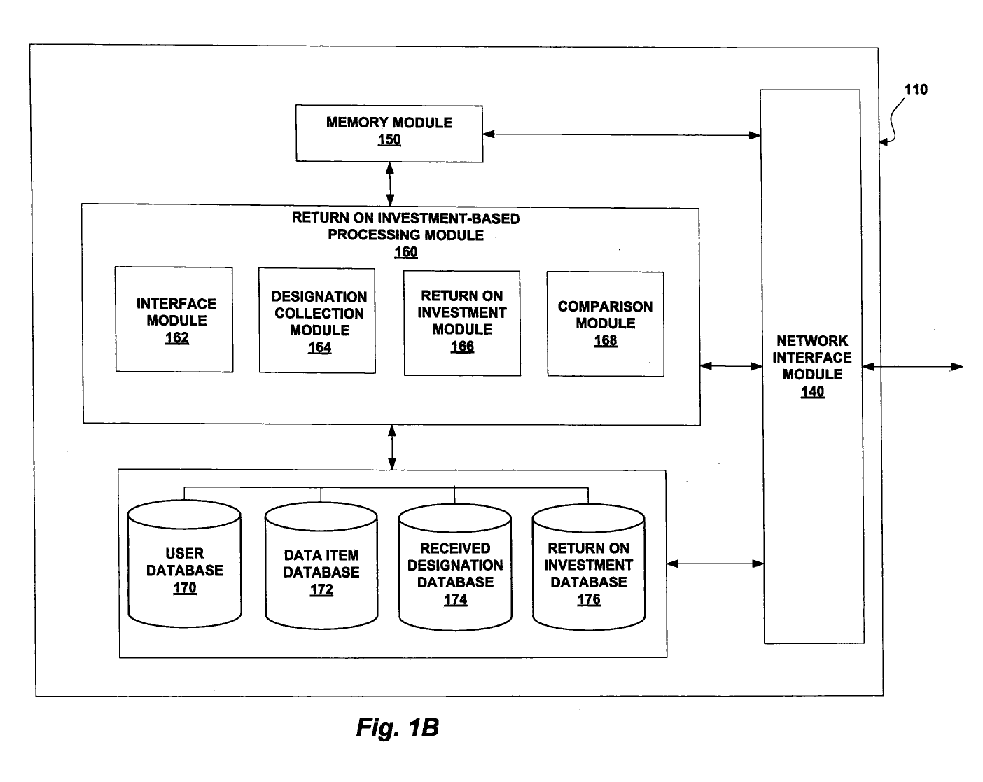

FIG. 1 is a block diagram of an exemplary ROI-based system 100 consistent with the present invention. One skilled in the art will appreciate that system 100 may be implemented in a number of different configurations without departing from the scope of the present invention. In the embodiment shown in FIG. 1, system 100 may include a return on investment-based server 110, a plurality of terminals 120-a to 120-n, and a network 130 for connecting server 110 with terminals 120. While FIG. 1 shows only one return on investment-based server 110 and two terminals 120, system 100 may include any number of servers 110 and terminals 120.

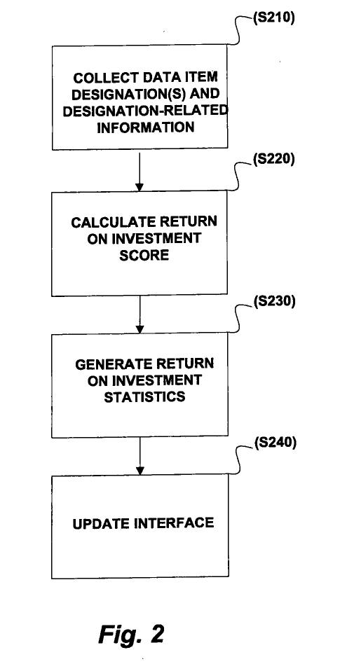

Return on investment-based server 110 may be a computing system that performs various functions. In one embodiment, server 110 may be configured to process requests received from terminals 120-a to 120-n to provide information associated with the designation of a data item (e.g., comments, statuses, ratings, goals, and the like) by a user, such as the designation that the data item is “helpful.” In response to the designation, server 110 may collect the data item designations, calculate the return on investment of the application, generate return on investment statistics, and update the interface of the application such that the updated interface is displayed to users of terminals 120-a to 120-n. The functions performed by return on investment-based server 110 are described in greater detail below with respect to, for example, FIGS. 2 to 7.

Each terminal 120 may be a computing system operated by a user. Terminal 120 may be used to display interface screens for displaying one or more data items, collecting designations of the data items, and sending the designations and information related to the designations to server 110 for processing. As shown in FIG. 1 (for simplicity, in terminal 120-a only), terminal 120 may include, for example, a processor 122, a memory 124, a display device 126, and an interface device 128. Processor 122 may be one or more processor devices, such as a microprocessor, laptop computer, desktop computer, workstation, mainframe computer, etc., that execute program instructions to perform various functions. Memory 124 may be one or more storage devices that store data (e.g., instructions, software applications, etc.) used by processor 122. In one embodiment, memory 124 may include browser software that enables terminal 120-a to 120-n to transmit and retrieve attribute-based data to and from server 110 using a protocol such as HTML. Display device 126 may be any known type of display device that presents information to the user operating terminal 120-a to 120-n. Interface device 128 may be one or more known interface device modules that facilitate the exchange of data between the internal components of terminal 120-a to 120-n and external components, such as server 110. In addition, interface device 128 may include a network interface device that allows terminals 120-a to 120-n to receive and send data to and from network 130.

Network 130 may be any type of network that facilitates communication between remote components, such as server 110 and terminals 120. For example, network 130 may be a local area network (LAN), a wide area network (WAN), a virtual private network, a dedicated intranet, the Internet, and/or a wireless network.

The arrangement illustrated in FIG. 1 is exemplary, and system 100 may be implemented in a number of different configurations without departing from the scope of the present invention. For example, components 110 and 120 may be directly connected, as opposed to being connected via network 130. Further, additional components may be included in system 100, such as a connection to other ROI-based systems or databases that may provide a designation to server 110. In addition, one or more terminals 120 may be included within return on investment-based server 110, thus allowing server 110 to receive requests from a user operating server 110 itself.

FIG. 1B is a block diagram of an exemplary embodiment of return on investment-based server 110. As shown in FIG. 1B, return on investment-based server 110 may further include a network interface 140, a memory module 150, a return on investment-based processing module 160, and one or more interconnected information storage databases, such as, for example, a user database 170, a data item database 172, a received designation database 174, and a return on investment database 176. While in the embodiment shown in FIG. 1B the information storage databases are interconnected, the information storage databases need not be interconnected. Moreover, rather than separate databases, attribute-based server 110 may include any number of databases, including a single database, that would include the data of databases 170, 172, 174, and 176.

Network interface 140 may be one or more devices that facilitate the transfer of information between server 110 and external components, such as terminals 120. Network interface module 140 may receive designations and designation-related information from terminals 120 and route those designations to processing module 160. In exemplary embodiments, network interface module 140 may be a web server that receives designations from terminals 120, forwards those requests to processing module 160, and returns the requested results to the requesting terminal 120 in the form of a web page.

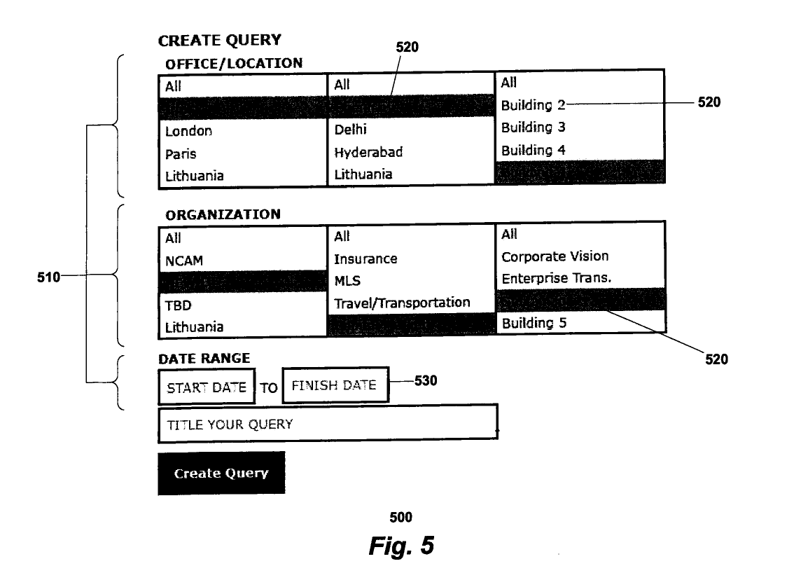

Memory module 150 may represent one or more storage devices that maintain information that is used by processing module 160 and/or other components internal and external to attribute-based server 110. Further, memory module 150 may include one or more programs that, when executed by an entity of processing module 160, perform one or more processes consistent with embodiments of the present invention. Examples of such processes are described in greater detail below, with respect to FIGS. 2 to 4. Memory module 150 may also include configuration data that may be used by processing module 160 to present user interface screens to terminals 120. Examples of such user interface templates or screens are described in greater detail with respect to FIGS. 5 to 7.

Processing module 160, as shown in FIG. 1B, may further include an interface module 162, a designation collection module 164, a return on investment module 166, and a comparison module 168. Interface module 162 may include components for preparing and presenting data items and user interface screens to terminals 120 via network interface 140. As described above, interface module 162 may retrieve and process designations from memory module 150 in presenting interface screens to terminal 120 via network interface 140.

Designation collection module 164 may include components for collecting a data item designation, as well as components for collecting information associated with the designation (hereinafter “designation-related information”). As described in more detail below, a designation collected by module 164 may include information describing whether the data item has been designated, for example, as “helpful.” Designation-related information may include information associated with the designation, such as the date of the designation, the time of the designation, the user who submitted the designation, the location of the user when the designation was made, and the like. Return on investment module 166 may include components for determining a return on investment of the entire application, of a particular data item category within the application, of a user, or the like. For example, and as described in greater detail below, return on investment module 166 may include a processor for calculating a return on investment score (hereinafter “ROI Score”) based on one or more of the collected designation, the designation-related information, and/or other data associated with the designation and designation-related information. Comparison module 168 may retrieve and process data from one or more or of modules 162, 164, and 166 and/or databases 170, 172, 174, and 176 (described below) to generate return on investment statistics.

As shown in FIG. 1B, attribute-based server 110 may also include a plurality of databases 170 to 176. In this regard, server 110 may include an access control module (not shown) having components for controlling access to databases 170 to 176. Such an access control module may include a query function that, in response to a comparison request, may query designation information stored in one or more of databases 170 to 176 to identify designations, designation-related information, return on investment statistics, and/or user information meeting specified criteria. Databases 170 to 176 may be configured using any appropriate type of known storage system configuration that facilitates the storage of data, as well as the locating, accessing, and retrieving of data stored in the databases (e.g., Sybase, Oracle, MySQL, SQL, Access, etc. databases).

User database 170 may contain information related to the users of the application, such as the name of the user, the office of the user, the location of the user within the office, the position and title of the user, the business unit of the user, and other information associated with the user's position within the organization.

Data item database 172 may contain one or more data items, as well as a category associated with each data item. System 100 may allow a user to review one or more data items in data item database 172 and designate one or more of these data items to create received designations and designation-related information. Received designation database 174 may then store this designation and/or designation-related information. For example, a designation may reflect whether the data item provides assistance to a user or whether the data item serves a useful function, such as whether the data item is “helpful.” As described in greater detail below, system 100 may also allow a user to review one or more items in databases 170 to 174 to generate return-on-investment statistics which are stored in return on investment database 176.

FIG. 2 is a flowchart demonstrating an exemplary process for calculating the return on investment of an application consistent with the present invention. For example, ROI-based system 100 may use the process of FIG. 2 to determine whether a user has designated that a data item in the application is “helpful” and then calculate the return on investment score of the application based on one or more data items and their associated designations. A data item may be displayed to a user by interface module 162.

As shown in FIG. 2, the process begins when designation collection module 164 collects a designation associated with the data item as well as designation-related information (S210). Upon receiving the designation and designation-related information, server 110 may store the designation and designation related information in received designation database 174.

Return on investment module 166 may then calculate the return on investment of the application by calculating a return on investment score (S220). More specifically, return on investment module 166 may collect designation and designation-related information from received designation database 174. In exemplary implementations, system 100 may calculate the return on investment score by promoting the user to enter a query, which may be predefined by return on investment module 166. In another exemplary implementation, system 100 may calculate the return on investment score in real-time. In this regard, return on investment module 166 may thus calculate the return on investment score using one or more data items from user database 170, data item database 172, and received designation database 174. This return on investment score may identify or reflect the extent to which the application is providing a return on investment. A more detailed description of the process for calculating the return on investment score is set forth below. Server 110 may store the return on investment score in return on investment database 176 and may use it to generate return on investment statistics (S230) and update the application interface at a terminal 120 via network interface 140 (S240).

System 100 may implement the process of FIG. 2 on an organization-wide basis so that the organization may monitor the return on investment of an application. For example, system 100 may perform stages 210 to 230 for the entire organization and then use the return on investment score and/or the return on investment statistics determined at stages 220 and 230 when determining whether to continue using an application either across the entire organization or in a particular office or business unit of the organization. For example, the organization may learn that the application is more helpful to an office in London than it is to an office in Paris, or that it is more helpful for a business unit dealing with insurance than it is to a business unit dealing with transportation. As another example, the organization may learn that a particular user's comments are predominantly helpful and determine that the user would benefit from advancement within the organization.

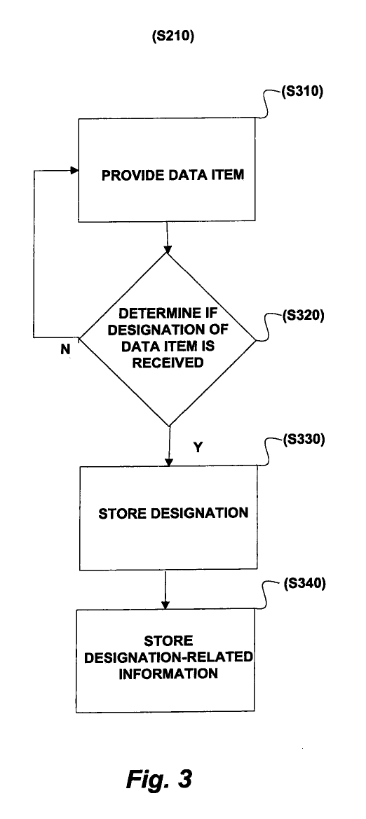

The above stages of FIG. 2 are described in greater detail below with respect to FIGS. 3 to 5. Referring now to FIG. 3, there is shown an exemplary process for implementing stage 210 of collecting the data item designations and designation-related information. As shown in FIG. 3, server 110 may provide the terminal 120 of the user with one or more data items (S310) via a user interface screen generated by interface module 162. Subsequently, the user may or may not input a designation for the one or more of data items into terminal 120. For example, the user may designate a first data item, such as a comment, as being “helpful,” and may not provide designations for any of the other data items presented to the user. In response, designation collection module 164 may determine whether a particular data item received a designation (S320) and, if so, may then store the designation (along with information identifying the particular data item) in one of databases 170 to 178 (S330). The designation collection module 164 may also store designation-related information (S340) in one or more of databases 170 to 178, such as the date and time of the designation, the user making the designation, and the like.

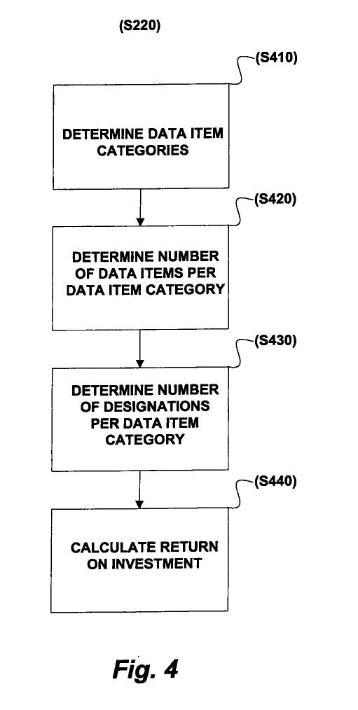

FIG. 4 illustrates an exemplary process for calculating a return on investment score as described above with respect to stage S220 of FIG. 2. As shown in FIG. 4, return on investment module 166 may calculate the return on investment score by retrieving data item categories from, for example, data item database 172 to determine the data item categories present in system 100 (S410). Return on investment module 166 and then may determine the total number of data items that are categorized in each data item category (S420). The return on investment module 166 may also determine whether the user has designated one or more of the data items and determine the number of designations per data item category (S430). Subsequently, the return on investment module may calculate the return on investment score (S440), which may represent the degree or extent to which the entire application or data category within the application provides a return on investment to the organization. The return on investment score may be calculated for the data item categories using the following exemplary formula represented by equation (1):

$$ROI Score Per Data Item Catergory = \frac{Total Number of Designations Per Data Item Category}{Total Number of Data Items Per Data Item Category} \qquad ( 1 )$$

Return on investment module 166 may also calculate a return on investment score for all of the data items, regardless of category, by summing each of the ROI scores for each of the data types and dividing by the total number of data types. For example, the return on investment score for all of the data items may be determined by using the exemplary formula represented by equation (2):

$$Total ROI Score = \frac{\sum ROI Score Per Data Item Category}{Total Number of Data Item Category} \qquad ( 2 )$$

To further illustrate the calculations performed by return on investment calculation module 166, an example will now be described. In the first example, there are only 3 data item categories: “A,” “B,” and “C.” There are 1000 data items that are classified in data item category “A,” 1500 data items that are classified in data item category “B,” and 600 data items that are classified in data item category “C.” Designation collection module 164 has received 1250 designations for one or more of these 1000 category “A” data items, 300 designations for one or more of these 1500 category “B” data items, and no designations for the 600 category “C” data items.

Return on investment based processing module 160 may thus perform the following calculations:

$$ROI Score Per Data Item Category = \frac{Total Number of Designations Per Data Item Category}{Total Number of Data Items Per Data Item Category}$$

$$ROI Score For Data Item Category {}_{}^{″}{A}{}_{}^{″} = \frac{1250}{1000} = 1.25$$

$$ROI Score For Data Item Category {}_{}^{″}{B}{}_{}^{″} = \frac{300}{1500} = 0.2$$

$$ROI Score For Item Category {}_{}^{″}{C}{}_{}^{″} = \frac{0}{600} = 0$$

$$Total ROI Score = \frac{( Summed ROI Scores Per Data Item Category )}{Total Number of Data Item Categories}$$

$$Total ROI Score = \frac{( 1.25 + 0.2 + 0 )}{3} = 0.48333333$$

After calculating ROI score(s), processing module 160 may transmit the ROI score for each data item category and/or the total ROI score to terminal(s) 120 for display.

The above calculations of return on investment-based module 166 are only exemplary, and module 166 need not complete each of the steps above to calculate the ROI score. For example, systems consistent with the invention need not perform the above calculations in the order described above and as shown in FIG. 4. Furthermore, exemplary systems consistent with the present invention need not perform ROI score calculations for each of the data item categories and, and as discussed in more detail below, may instead filter information from one or more of databases 170 to 178 to perform ROI score calculations in response to query parameters set by a user. Additionally, any known system to determine the total number of designations and total number of data items may be used, such as a real-time counter.

FIG. 5 illustrates an exemplary query display 500 for generating return on investment statistics as described above with respect to stage S230 of FIG. 2. Exemplary query display 500 may be generated by comparison module 168 to allow users to filter the data contained in one or more of databases 170-178 and generate return on investment statistics. Query display 500 may include one or more information request areas 510 indicating the type of information requested, as well as one or more predetermined sample inputs 520 to guide the user in completing the information request. Additionally, query display 500 may include one or more text entry boxes 530 in which the user can submit additional query information, such as a date range. In the exemplary embodiment shown in FIG. 5, the request areas 510 include the “office/location” associated with the users who submitted the data items and the “organization” associated with the users who submitted the data items. In this instance, the user submitting the query selected the users who submitted data items who are located in Building 4 of the Chennai, India office, and are who part of the “Sustainability” business unit.

While the embodiment shown in FIG. 5 only includes a query for one office and one organization, the user may select multiple offices and/or organizations for which to create the query. Additionally, while in the embodiment shown in FIG. 5 three exemplary query information request areas are provided, systems consistent with the invention may pose any number of query information requests, and in a variety of formats, for obtaining query information. For example, instead of selection or text-entry boxes, server 110 may prompt the user to select a check box or the like. As another example, users may enter information that is not a predetermined sample input. As yet another example, the system may be able to query by data item type or by user. After providing the user's selections, the user may use create query box 530 to enter and submit the query information to server 110.

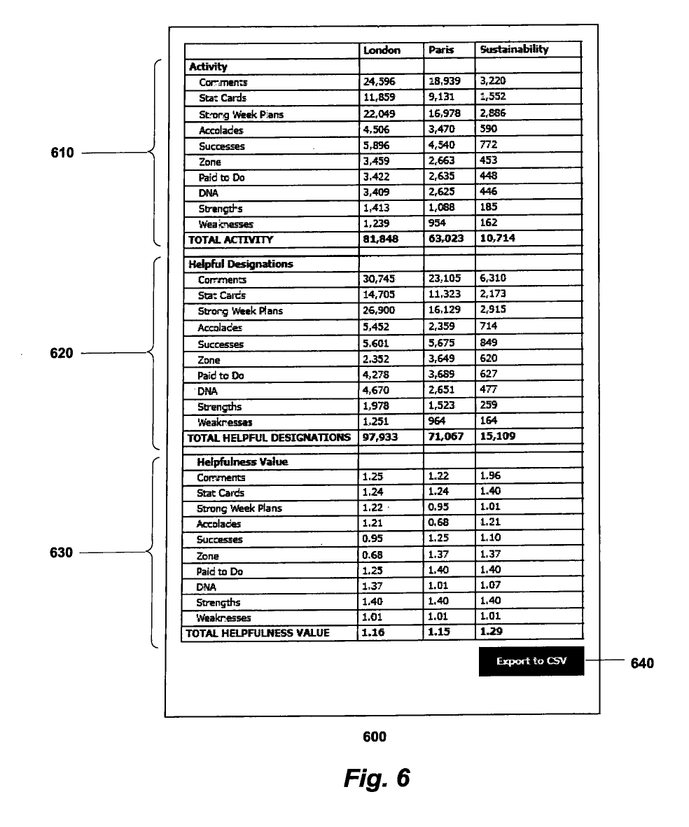

Referring now to FIG. 6, after the query information has been submitted to server 110, server 110 may use the query information to generate return on investment statistics, to calculate various ROI scores, and to generate a return on investment statistics display screen 600. Server 110 may display screen 600 in response to a query that includes information populated by one or more of modules 162, 164, 166, and 168, and/or by databases 170, 172, 174, and 176. Display screen 600 may be divided into a number of subsections, such as, for example, the Activity Section 610, the Designation Section 620, and the Return On Investment Section 630. As shown in FIG. 6, server 110 has filtered the information in databases 172-178 to separate the total number of data items per data item category (see Activity Section 610), the number of designations per data item category (see Designation Section 620), and the return on investment score per data item category (see Return on Investment Section 630) for the London and Paris Offices as well as the Sustainability Business Unit. These return on investment statistics may be stored in one or more of databases 172-178, or can be exported to CSV format by, for example, clicking on button 640.

In the instance shown in FIG. 6, in addition to querying the return on investment statistics for the entire London and Paris offices and the Sustainability Business Unit, the user has also specified the following data categories for the query: (1) “Comments”; (2) “Stat Cards”; (3) “Strong Week Plans”; (4) “Accolades”; (5) “Successes”; (6) “Zone”; (7) “Paid to Do”; (8) “Strengths”; (9) “Weaknesses.” As shown in FIG. 6, server 110 has generated various return on investment statistics in the subsections of display screen 600 by using information populated by one or more of modules 162, 164, 166, and 168, and/or contained in databases 170, 172, 174, and 176. For example, server 110 has used the office location information contained in user database 170 and the designation and designation-related information in received designation database 174 to separate the data items generated by users in the London office, as well as the designations and designation-related information associated with those data items. As shown in FIG. 6, the London office generated 24,596 data items classified as “comments” as well as 30,745 designations associated with one or more of those comments. Furthermore, Return on investment module 166, using the separated data, has generated a ROI score for the “Comments” data item category as 1.25, and a total ROI score for all of the selected data item categories in the London office of 1.16.

While the user has requested return on investment statistics for the designation of “helpfulness” in the exemplary embodiment shown in FIG. 6, exemplary embodiments consistent with the present invention may request return on investment statistics for more than one type of designation. Furthermore, the return on investment statistics are not limited to the items shown in FIG. 6, as any information generated by modules 162-168 or contained in databases 170-176 may be displayed to the user via a display screen 600 and may be queried by server 110.

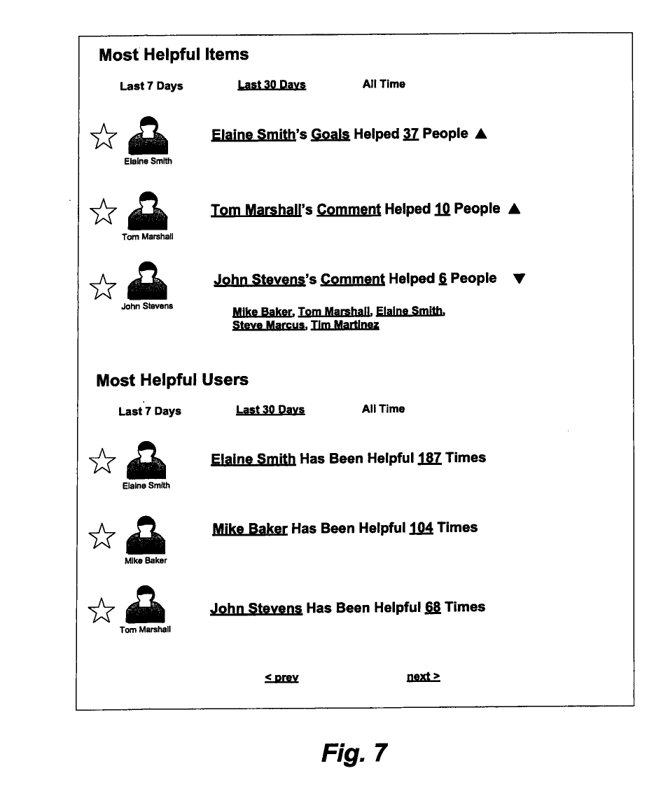

Referring now to FIG. 7, system 100 may also update the application via user interface module 162 to include information populated by one or more of modules 162, 164, 166, and 168, and/or by databases 170, 172, 174, and 176. For example, server 110 may display the data items that may include the most designations, as well as designation-related information. In the exemplary embodiment shown in FIG. 7, the data item which was categorized as a “Goal” was designated 37 times and was generated by the user “Elaine Smith.” As another example, server 110 may display how many times the user has made a designation, allow the user to determine the time period for the display, the users who designated a particular item, and the like. Thus, each user's data items and designations may be visible to other users.

System 100 may also include a number of security controls to prevent skewed ROI scores. For example, system 100 may allow a user to designate a data item only once, and subsequent attempts to designate the data item would result in the designation not being entered into the system and the user receiving an error message. Additionally, the system 100 may prevent a user from designating a data item that he or she created.

As described above, systems and methods consistent with the invention provide an attribute-based system that allows an organization to manage the attributes or strengths of its members. For purposes of explanation only, certain aspects and embodiments are described herein with reference to the components illustrated in 1-. The functionality of the illustrated components may overlap, however, and may be present in a fewer or greater number of elements and components. Further, all or part of the functionality of the illustrated elements may co-exist or be distributed among several geographically dispersed locations. Moreover, embodiments, features, aspects and principles of the present invention may be implemented in various environments and are not limited to the illustrated environments.

Further, the sequences of events described in FIGS. 1A-7 are exemplary and not intended to be limiting. Thus, other process stages may be used, and even with the processes depicted in FIGS. 1A-7, the particular order of events may vary without departing from the scope of the present invention. Moreover, certain process stages may not be present and additional stages may be implemented in FIGS. 1A-7. Also, the processes described herein are not inherently related to any particular system or apparatus and may be implemented by any suitable combination of components.

Furthermore, the system may not need to determine the return on investment score for all of the data item types and may instead determine the return on investment score in response to a query entered by a user, discussed in more detail above with respect to FIGS. 6 and 7.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-readable storage medium having instructions which, when executed on a processor, perform a method for calculating a return on investment of an application for an organization, the method comprising:
receiving a plurality of data items that reflect content created by a user, each of the plurality of data items corresponding to data item categories;
receiving a plurality of designations associated with the data items; and
calculating return on investment scores for the data item categories based on the designations and the data items.

2. The computer-readable storage medium of claim 1, wherein calculating the return on investment scores further comprises:
determining total numbers of data items for the data item categories;
determining total numbers of designations for the data item categories; and
dividing the total numbers of designations for the data item categories by the total numbers of data items for the data item categories.

3. The computer-readable storage medium of claim 2, further comprising:
calculating a total return on investment score by summing the return on investment scores for the data item categories to generate a summed value, and dividing the summed value by the total number of data item categories.

4. The computer-readable storage medium of claim 1, further comprising:
receiving designation-related information associated with each of the designations;
receiving user information associated with users of the application, the user information comprising the names of the users and the locations of the users;
receiving query information indicating a first search parameter and a second search parameter;
comparing the first search parameter and the second search parameter to the user information, designations, and designation-related information to determine a query match;
generating return on investment statistics based on the query match; and
displaying the return on investment statistics.

5. The computer-readable storage medium of claim 4, further comprising updating the application with at least one of the return on investment statistics and the return on investment scores.

6. The computer-readable storage medium of claim 1, further comprising:
determining whether each data item has received the designations;
storing the designations; and
storing designation-related information associated with the designations, the designation-related information comprising the users who created the designations and the dates of the designations.

7. The computer-readable storage medium of claim 1, wherein the return on investment scores are calculated in real-time.

8. A system for calculating a return on investment of an application for an organization comprising:
a module for receiving a plurality of data items that reflect content created by a user, each of the plurality of data items corresponding to data item categories;
a module for receiving a plurality of designations associated with the data items; and
a module for calculating return on investment scores for the data item categories based on the designations and the data items.

9. The system of claim 8, wherein the module for calculating return on investment scores:
determines total numbers of data items for the data item categories;
determines total numbers of designations for the data item categories; and
divides the total numbers of designations for the data item categories by the total numbers of data items for the data item categories.

10. The system of claim 8, wherein the module for calculating return on investment scores:
calculates a total return on investment score by summing the return on investment scores for the data item categories to generate a summed value, and dividing the summed value by the total number of data item categories.

11. The system of claim 8, further comprising:
a module for receiving designation-related information associated with each of the designations;
a module for receiving user information associated with users of the application, the user information comprising the names of the users and the locations of the users;
a module for receiving query information indicating a first search parameter and a second search parameter;
a module for comparing the first search parameter and the second search parameter to the user information, designations, and designation-related information to determine a query match;
a module for generating return on investment statistics based on the query match; and
a module for displaying the return on investment statistics.

12. The system of claim 8, further comprising:
a module which updates the application with at least one of the return on investment statistics and the return on investment score.

13. The system of claim 8, further comprising:
a module for determining whether each data item has received the designations;
a module for storing the designations; and
a module storing designation-related information associated with the designations, the designation-related information comprising the users who created the designations and the dates of the designations.

14. The system of claim 8, wherein the module for calculating return on investment scores calculates the return on investment scores in real-time.

15. A method for calculating a return on investment of an application for an organization, the method comprising:
receiving a plurality of data items that reflect content created by a user, each of the plurality of data items corresponding to data item categories;
receiving a plurality of designations associated with the data items; and
calculating return on investment scores for the data item categories based on the designations and the data items.

16. The method of claim 15, wherein calculating the return on investment scores further comprises:
determining total numbers of data items for the data item categories;
determining total numbers of designations for the data item categories; and
dividing the total numbers of designations for the data item categories by the total numbers of data items for the data item categories.

17. The method of claim 16, further comprising:
calculating a total return on investment score by summing the return on investment scores for the data item categories to generate a summed value, and dividing the summed value by the total number of data item categories.

18. The method of claim 15, further comprising:
receiving designation-related information associated with each of the designations;
receiving user information associated with users of the application, the user information comprising the names of the users and the locations of the users;
receiving query information indicating a first search parameter and a second search parameter;
comparing the first search parameter and the second search parameter to the user information, designations, and designation-related information to determine a query match;
generating return on investment statistics based on the query match; and
displaying the return on investment statistics.

19. A computer-readable storage medium having instructions which, when executed on a processor, perform a method for calculating a return on investment of an application for an organization, the method comprising:
receiving a plurality of data items that reflect content created by a user, the data items corresponding to data item categories;
receiving designation-related information associated with each of the designations;
receiving user information associated with users of the application, the user information comprising the names of the users and the locations of the users;
receiving query information indicating a first search parameter and a second search parameter;
comparing the first search parameter and the second search parameter to the user information, designations, and designation-related information to determine a query match; and
calculating a return on investment score for the data item categories based on the query match, total numbers of designations associated with the query match, and total numbers of data items associated with the query match.

20. The computer-readable storage medium of claim 19, wherein the first search parameter indicates the data item category and the second search parameter indicates the location of the user that created the data item
